(19) United States
(12) Patent Application Publication
(10) Pub. No.: US 2005/0113231 A1
(43) Pub. Date: May 26, 2005

(54) Nip roll of a paper or board machine

(76) Inventors: Eero Suomi, Hameenlinna (FI); Markus Laitila, Jarvenpaa (FI); Timo Torvi, Helsinki (FI); Hannu Vuorikari, Helsinki (FI)

Correspondence Address: STIENNON & STIENNON, 612 W. MAIN ST., SUITE 201, P.O. BOX 1667, MADISON, WI, 53701-1667, US

(21) Appl. No.: 10/506,707

(22) PCT Filed: Mar. 7, 2003
(86) PCT No.: PCT/FI03/00174

(30) Foreign Application Priority Data
Mar. 13, 2002 (FI) 20020465

(51) Int. Cl. B25F 5/02; B30B 15/34

(52) U.S. Cl. 492/58; 100/330

(57) ABSTRACT

A nip roll of a paper or board machine is a heatable roll manufactured of steel. The thermal shock resistance of the roll is over 6,000 W/m².

### CROSS REFERENCES TO RELATED APPLICATIONS

This application is a U.S. National Stage application of International App. No. PCT/F103/00174, filed Mar. 7, 2003, and claims priority on Finnish Application No. 20020465, Filed Mar. 13, 2002.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates to nip rolls of paper or board machines.

JP-A-52121510 discloses a nip roll of a paper machine which is manufactured of steel.

Various calendering concepts are known from prior art, one of which is long nip calendering. Long nip calendering can be based on shoe press technology or on belt/roll technology. In shoe calendering, shoe press technology known from the press section is used and the shoe roll comprises a shoe, loading elements, a lubricating oil system and a belt. A thermo roll is used as the other roll of the calendering nip, which roll can be a water-, steam-, oil-, or induction-heated roll. A belt calender comprises a thermo roll, a belt loop and a backing roll, which may be either a hard or a soft roll, and the belt circulates over the backing roll and the guide/tension rolls. In the long nip calendering process large amounts of heat are transferred from the thermo roll to paper and the great heat amounts generate high thermal stresses and rapid stress gradients in the thermo roll, in which case the properties (durability) of the cast iron rolls used at present are no longer sufficient for the desired process conditions. In addition, the stress states in the roll during its use may vary in the direction of thickness of the material of the roll, to which the materials used today, e.g. chill casting, are poorly resistant.

In today's paper and board machines the calendering process is often connected as an on-line unit to a paper or board machine, in which case, e.g. the changing and cleaning of the roll have to take place quickly in order to avoid wasting valuable capacity. This is problematic, since, according to industrial safety regulations, the temperature of a hot roll must be under 60° C. before it can be changed and, on the other hand, the working temperature of the roll is as high as 200° C. Prior art chilled rolls withstand a temperature change rate of 2° C./min., due to which a considerable amount of time and capacity has been lost in connection with the changing or cleaning of the roll. This has even partly led to the attempt to clean the rolls quickly, for example with a pressure washer, with the result that the roll cools down too quickly with respect to its strength, and thus serious damage may have been caused to the roll.

Rolls having a steel surface are also known from prior art-one example being disclosed in U.S. Pat. No. 6,203,307. In the hot soft nip calender disclosed in the patent, rolls with a steel outer surface are used as calender rolls to be heated. In traditional soft calendering the heat amounts transferred are, however, considerably smaller than in long nip calendering.

Arrangements in which the wear resistance of the steel roll has been provided by coating are known from prior art. Some such arrangements are disclosed in U.S. Pats. Nos. 4,452,647 and 5,167,068.

With respect to prior art, reference is also made to U.S. Pat. No. 5,334,125 and EP-A-369 968. U.S. Pat. No. 5,334,125 discloses a martensite roll which has a cast-iron shell. The surface layer of the roll shell is hardened and tempered such that the structure of the surface layer of the roll shell is martensitic. Published EP application 369 968 discloses an arrangement in a paper machine, in which the surface properties of a roll and/or rolls are affected by regulating the temperature of the roll surface by means of an external heating device. In the arrangement, such a combination of a heating device and a roll coating is used that the heating radiation penetrates through the paper or only directly to the roll surface but does not heat the roll itself at a greater depth.

A very long nip, typically being over 30 mm, and high temperatures, the surface temperature of the roll typically being over 160° C. (the interior of the roll can be even considerably hotter), and possibly moisturizing of the paper/board web with water or steam are needed in the long nip calendering process. These factors do not enable the manufacture of the machine, especially of the thermo roll of the nip, by means of the traditional technique, or, if manufactured traditionally, the machine has a low fault tolerance in case of a process failure.

### SUMMARY OF THE INVENTION

In modern paper and board machine rolls, particularly nip rolls, which withstand dramatic changes in the process conditions are needed, and it is an important object of the invention to provide such a roll.

A special object of the invention is to provide a long nip calender roll that withstands the high thermal stresses caused by the long nip process and enables an efficient heat transfer to paper.

It is an object of the invention to provide a roll resistant to thermal shock. Thermal shock has been dealt with, e.g. in the book “The Science and Engineering of Materials” by Donald R. Askeland, pp. 740-741, Chapman & Hall, 1996 (Third S.I. Edition).

An object of the invention is also to provide a roll that withstands rapid temperature changes.

### BRIEF DESCRIPTION OF THE DRAWINGS

Not applicable.

### DESCRIPTION OF THE PREFERRED EMBODIMENTS

The problem underlying the invention can be solved in a new and inventive way by changing the material used from cast iron to steel, meaning that, according to the invention, the heatable thermo roll of a long nip calender is manufactured of steel.

The roll according to the invention withstands thermal shock and its thermal shock coefficient is over 6000 W/m², which is due to the properties of the roll: ductility, very high strength properties, wear resistance. A roll having, at the same time, these three important qualities, with which considerable advantages are achieved, is not known from prior art. The material of the roll according to the invention is pure and homogeneous in the thickness direction of the wall; most appropriately the entire layer involved in the heat transfer process is homogeneous, i.e. comprises one phase, i.e. one crystal structure. Most advantageously the roll wall is martensite or bainite and does not contain retained austenite. The roll may also be entirely homogeneous.

The dynamic properties of the roll according to the invention are at a high level, whereby the vibration problems are diminished.

The properties of the roll according to the invention, most appropriately a steel roll in a quenched and tempered state, are preferably the following: surface hardness is 400-500 HV₂₀, modulus of elasticity over 200,000 MPa, tensile strength over 1,000 MPa, bending fatigue strength over 350 MPa, thermal conductivity over 30 W/mK, elongation at fracture over 7%, and dynamic ductility over 20 J.

The roll according to the invention is also particularly well suitable for use in future processes, since it is very durable thanks to good ductility, strength and wear resistance properties and, in addition, its structure is very homogeneous, which also adds to its durability.

The material of the roll according to the invention is most preferably tempering steel and its crystal structure is most appropriately martensitic or bainitic. Most advantageously the material of the roll according to the invention is homogeneous tempering steel which has been induction hardened and tempered.

In this description a nip roll refers to a roll forming a nip with another roll, in which the contact between the rolls is usually given in MPa units and the nip length is over 4 mm.

According to an advantageous characteristic of the invention the surface properties, e.g. hardness, of the roll can be altered, if necessary, by hard coating the roll, whereby the hardness of the base material of the roll may be of the order of 250 MPa.

The roll according to the invention advantageously has one or more of the following properties:
The shell of the roll is forged from a steel slab or it is a steel casting or otherwise manufactured of steel, such as, by bending from a plate.
The roll is heated, for example by means of a heat transfer medium flowing inside the roll, e.g. by means of water, steam, oil, air; by resistors, external or internal induction; there can be a heat production unit inside the roll, or by means of a combination of two or more of the above. The roll is most appropriately heated so that the heat is distributed evenly over the surface of the shell of the roll.
The steel shell of the roll may be coated (e.g. welding or plasma spraying) with a wear resistant material, with which the surface hardness is increased. The coating may also serve as a protection against chemical wear.
The steel shell of the roll is surface hardened or through hardened or unhardened. Suitable hardening methods include, for example, induction hardening, flame hardening, laser hardening, case hardening, nitrate hardening or other such heat treatment according to the quenching and tempering treatment.
The steel roll can also be manufactured of one or more different materials.
The roll surface made of a different material may also be a several millimeters thick shell enveloping the inner part of the roll, e.g. a tempering steel shell over a cast iron central portion.
The structure of the roll may enable the evaporation of water in the nip. The roll may be a conventional roll or the roll may be formed only of a rotating shell, such as a roll similar to the one marketed by Metso Paper, Inc. under the trademark SymRoll.
The roll can be cooled and heated by means of a medium, e.g. water. The properties of the roll surface, e.g. hardness and thermal conductivity, may vary in the cross machine direction (direction of the roll axis).

Thermal shock i.e. heat shock in materials is affected by several factors: the coefficient of thermal expansion, thermal conductivity, the modulus of elasticity, fracture stress and phase transformations. Thermal shock can thus be derived from the equation

$$\frac{{σ}_{f} k}{E α} ,$$

where
σ_{f}=the fracture stress of the material,
k=the thermal conductivity,
E=the modulus of elasticity, and
α=the linear coefficient of thermal expansion.

The roll according to the invention is advantageously suitable for use as a nip roll of a paper or board machine, especially in nips in which a great heat transfer from the roll to the web occurs. Advantageous applications are, for example, thermo roll of a calender (e.g. super-, multiroll, OptiLoad, long nip and soft calenders).

The roll according to the invention withstands rapid temperature changes, whereby, for example, it does not take as much time to change or clean it and, in addition, the heating and cooling phases, in which a lot of capacity is lost, naturally become considerably quicker.

Table 1 shows in an exemplifying manner a comparison between the material properties of a prior art roll manufactured of chill casting material and of a roll manufactured of tempering steel according to a preferable application of the invention.

TABLE 1

| Property | Chill casting | Tempering steel |
|---|---|---|
| Tensile strength at | about 250 N/mm² | about 1400 N/mm² |
| fracture | | |
| Yield stress | no yield stress | about 1100 N/mm² |
| | (white cast iron) | |
| Elongation A5 | no remarkable elongation | more than 8% |
| | less than 0.2% | |
| Surface hardness | about 550-590 HV20 | 420-480 HV20 |
| | | (through the entire |
| | | shell of the roll) |
| Thermal conductivity | 24 W/mK | 30-40 W/mK |
| | (white cast iron) | |
| | surface layer about 10 | |
| | mm | |
| Thermal conductivity | 48 W/mK | |
| | (grey cast iron) | |
| | interior | |

1-8. (canceled)

9. A nip roll of a paper or board machine comprising a heatable roll manufactured of steel, having a thermal shock resistance greater than 6000 W/m², a tensile strength greater than 1000 MPa, an elongation at fracture greater than 7%, a dynamic ductility greater than 20 J, and a surface hardness greater than 400 HV₂₀.

10. The roll of claim 9 wherein the material of the roll is quenched and tempered steel.

11. The roll of claim 10 wherein the tempered steel is at a basic hardness of about 250 HV₂₀.

12. The roll of claim 10 wherein the tempered steel has a hardness in the quenched and tempered state which is greater than 400-500 HV₂₀.

13. The roll of claim 9 wherein the roll has a surface which is hard coated to increase wear resistance.

14. The roll of claim 9 wherein the roll has a surface which is heat treated by induction hardening to increase wear resistance.

15. The roll of claim 9 wherein the roll has a shell which is made of at least two different materials.

16. The roll of claim 9 further comprising a long nip calender formed with the roll.

17. A calender comprising:
a first calendering element selected from the group consisting of: a shoe roll, and a belt/roll;
a backing roll having at least a first layer forming a backing roll surface, the first layer having a thickness, and the roll surface forming a long nip of greater than 30 mm in length with the first calendering element;
a means for heating the backing roll surface to greater than 160° C.;
a web in heat transfer relation to the backing roll surface;
wherein the the first layer forming a backing roll surface is homogeneous in a direction defined by the thickness of the first layer and is formed of steel in a quenched and tempered state, so that the hardness of said surface is greater than 400 HV₂₀, the first layer having a modulus of elasticity of greater than 200,000 MPa, a tensile strength of greater than 1,000 MPa, a bending fatigue strength greater than 350 MPa, a thermal conductivity of greater than 30 W/mK, an elongation at fracture of greater than 7% and a dynamic ductility greater than 20 J.

18. The calender of claim 17 wherein the first layer is formed of martensite or bainite.

19. The calender of claim 17 wherein the backing roll is formed of the first layer enveloping an inner part of the backing roll.

20. The calender of claim 17 wherein the backing roll surface is coated with a wear resistant material, whereby the surface hardness is increased.

21. A method of calendering a web comprising the steps of:
forming a backing roll having at least a first layer, the first layer forming a backing roll surface, the first layer having a thickness, and the roll surface forming a long nip of greater than 30 mm in length with a first calendering element, wherein the the first layer is homogeneous in a direction defined by the thickness of the first layer and is formed of steel in a quenched and tempered state, so that the hardness of the surface is greater than 400 HV₂₀, the first layer having a modulus of elasticity of greater than 200,000 MPa, a tensile strength of greater than 1,000 MPa, a bending fatigue strength greater than 350 MPa, a thermal conductivity of greater than 30 W/mK, an elongation at fracture of greater than 7% and a dynamic ductility greater than 20 J;
heating the backing roll surface to greater than 160° C.; and
passing a web through the long nip to produce a thermal shock of greater than 6,000 W/m² in the first layer of the backing roll.

22. The method of claim 21 wherein the backing roll is formed of the first layer enveloping an inner part of the backing roll.

23. The method of claim 21 wherein the backing roll surface is coated with a wear resistant material, increasing the surface hardness.
